(19) United States
(12) Patent Application Publication
(10) Pub. No.: US 2025/0211688 A1
(43) Pub. Date: Jun. 26, 2025

(54) CO2 EMISSIONS ESTIMATION SYSTEM AND NON-TRANSITORY COMPUTER-READABLE RECORDING MEDIUM WITH CO2 EMISSIONS ESTIMATION PROGRAM STORED THEREON

(71) Applicant: KYOCERA Document Solutions Inc., Osaka (JP)

(72) Inventors: Naoki TAKEUCHI, Osaka (JP); Masahiro SUZUKI, Osaka (JP); Motoki HIRATSUKA, Osaka (JP); Ryota YAGANE, Osaka (JP); Manori DISSANAYAKE, Osaka (JP)

(73) Assignee: KYOCERA Document Solutions Inc., Osaka (JP)

(21) Appl. No.: 18/999,437

(22) Filed: Dec. 23, 2024

(30) Foreign Application Priority Data
Dec. 25, 2023 (JP) 2023-217690

(51) Int. Cl. H04N 1/00

(52) U.S. Cl. CPC H04N 1/00068; H04N 1/00015; H04N 1/00074

(57) ABSTRACT

A CO2 emissions estimation system includes a control device including a processor and functioning, through the processor executing a CO2 emissions estimation program, as an emissions estimator. The emissions estimator determines an estimated value of CO2 emissions from an image forming apparatus, using an estimation model as a formula for estimating the emissions. When a number of sheets subjected to a particular job on the image forming apparatus in a specified period is 1 or more, the emissions estimator determines an estimated value of the emissions in the specified period using a first estimation model as the estimation model. When the number of sheets subjected to the particular job in the specified period falls short of 1, the emissions estimator determines an estimated value of the emissions in the specified period using as the estimation model a second estimation model different from the first estimation model.

### INCORPORATION BY REFERENCE

This application claims priority to Japanese Patent Application No. 2023-217690 filed on Dec. 25, 2023, the entire contents of which are incorporated by reference herein.

### BACKGROUND

The present disclosure relates to CO2 emissions estimation systems that estimate CO2 emissions from image forming apparatuses, and non-transitory computer-readable recording media with CO2 emissions estimation programs stored thereon.

There is known a CO2 emissions estimation system that multiplies a reference amount of power previously determined from measurement of a power consumption of an image forming apparatus by a print mode factor associated with a print mode indicating that images are to be printed in black and white or multicolor, further multiplies the obtained value by a layout factor associated with a layout indicating the number of pages to be printed per sheet of paper to obtain a power consumption of the image forming apparatus when performing one job, and multiplies the obtained power consumption by CO2 emissions per unit power consumption to determine an estimated value of CO2 emissions from the image forming apparatus. In this CO2 emissions estimation system, the reference amount of power is considered as, for example, an amount of power consumed by black and white printing on a page of A4 paper. The print mode factor is set at “1” in a print mode where images are printed in black and white, and a greater value than “1” in another print mode where images are printed in multicolor. The layout factor is set at “1” in a layout “nothing” where one page of a document is printed on one side of a single sheet of paper, “0.5” in a layout “2 in 1” where two pages of a document are printed on one side of a single sheet of paper, “0.25” in a layout “4 in 1” where four pages of a document are printed on one side of a single sheet of paper, and “0.125” in a layout “8 in 1” where eight pages of a document are printed on one side of a single sheet of paper.

There is also known another CO2 emissions estimation system that multiplies respective power consumptions of actuated devices, each power consumption defined for the relevant actuated device and depending on print settings, by the numbers of actuations of the actuated devices, respectively, each number of actuations depending on the numbers of sheets and sides to be printed, to obtain a power consumption of an image forming apparatus when performing one job and multiplies the obtained power consumption by a CO2 emissions factor depending on the type of power to determine an estimated value of CO2 emissions from the image forming apparatus.

### SUMMARY

A technique improved over the aforementioned techniques is proposed as one aspect of the present disclosure.

A CO2 emissions estimation system according to an aspect of the present disclosure includes a control device including a processor and functioning, through the processor executing a CO2 emissions estimation program, as an emissions estimator. The emissions estimator determines an estimated value of CO2 emissions from an image forming apparatus, using an estimation model as a formula for estimating the emissions. Furthermore, when the number of sheets subjected to a particular job on the image forming apparatus in a specified period is 1 or more, the emissions estimator determines an estimated value of the emissions in the specified period using a first estimation model as the estimation model. When the number of sheets subjected to the particular job on the image forming apparatus in the specified period falls short of 1, the emissions estimator determines an estimated value of the emissions in the specified period using as the estimation model a second estimation model different from the first estimation model.

Another aspect of the present disclosure is a non-transitory computer-readable recording medium with a CO2 emissions estimation program stored thereon. The CO2 emissions estimation program allows a computer to realize an emissions estimator that determines an estimated value of CO2 emissions from an image forming apparatus, using an estimation model as a formula for estimating the emissions. When the number of sheets subjected to a particular job on the image forming apparatus in a specified period is 1 or more, the emissions estimator determines an estimated value of the emissions in the specified period using a first estimation model as the estimation model. When the number of sheets subjected to the particular job on the image forming apparatus in the specified period falls short of 1, the emissions estimator determines an estimated value of the emissions in the specified period using as the estimation model a second estimation model different from the first estimation model.

### BRIEF DESCRIPTION OF THE DRAWINGS

FIG. 1 is a block diagram showing an example of an image forming apparatus serving as a CO2 emissions estimation system according to one embodiment of the present disclosure.

FIG. 2 is a table showing an example of sleep mode setting value information shown in FIG. 1.

FIG. 3 is a table showing an example of sleep mode setting value information shown in FIG. 1.

FIG. 4 is a table showing an example of estimated emissions information shown in FIG. 1.

FIG. 5 is a block diagram showing an example of a model generation system for generating a CO2 emissions estimation model for use on the image forming apparatus shown in FIG. 1.

FIG. 6 is a flowchart of a method for generating a CO2 emissions estimation model for use on the image forming apparatus shown in FIG. 1.

FIG. 7 is a flowchart of an operation of the image forming apparatus shown in FIG. 1 when performing a copy job.

FIG. 8 is a flowchart of an operation of the image forming apparatus shown in FIG. 1 when changing a sleep mode setting value.

FIG. 9 is a flowchart of an operation of the image forming apparatus shown in FIG. 1 when displaying an estimated value of CO2 emissions.

FIG. 10 is a flowchart of CO2 emissions estimation processing shown in FIG. 9.

FIG. 11 is a view showing an example of a screen that displays estimated values of CO2 emissions from the image forming apparatus shown in FIG. 1.

FIG. 12 is a block diagram showing another example of a CO2 emissions estimation system according to the one embodiment of the present disclosure different from the example shown in FIG. 1.

### DETAILED DESCRIPTION

First, a description will be given of the configuration of an image forming apparatus serving as a CO2 emissions estimation system according to one embodiment of the present disclosure.

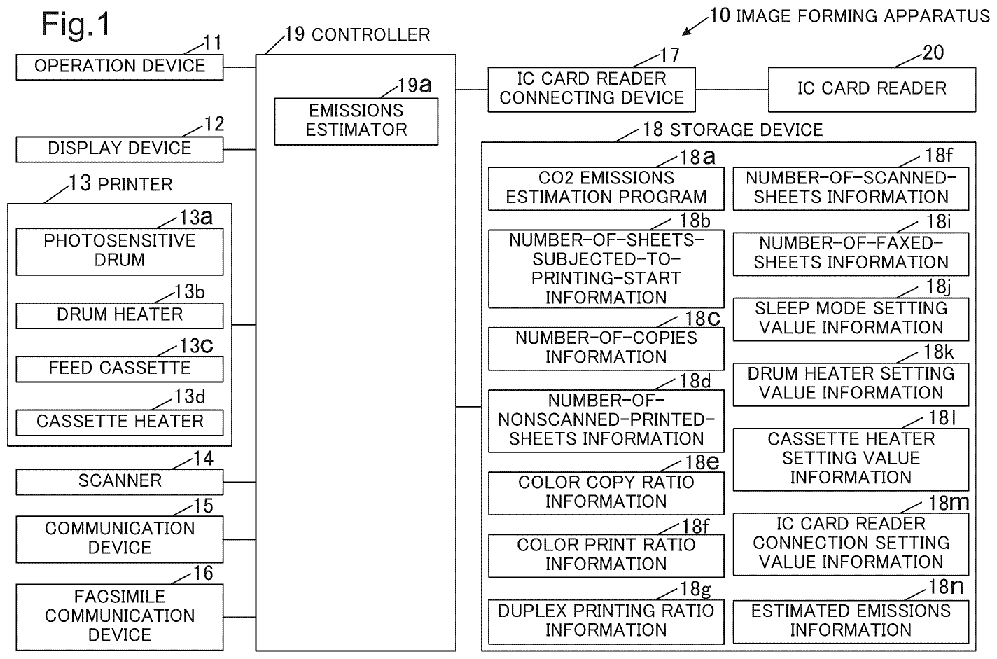

FIG. 1 is a block diagram showing an example of an image forming apparatus 10 according to this embodiment.

As shown in FIG. 1, the image forming apparatus 10 is a computer that includes: an operation device 11 through which various operations are to be input and which is composed of, for example, buttons; a display device 12 on which various types of information are to be displayed and which is composed of, for example, an LCD (liquid crystal display); a printer 13 as a printing device that prints an image on a recording medium, such as a sheet of paper; a scanner 14 as a reading device that reads an image from an original document; a communication device 15 that communicates by wire or directly by wireless with external devices via a network, such as a LAN (local area network) or the Internet, or without a network connection; a facsimile communication device 16 that performs facsimile communications with unshown external facsimile devices via a communication line, such as a public phone line; an IC (integrated circuit) card reader connecting device 17 capable of being connected with an IC card reader 20 that reads information from an IC card; a non-volatile storage device 18 which stores various types of information and which is composed of, for example, a semiconductor memory or an HDD (hard disk drive); and a controller 19 that performs overall control of the image forming apparatus 10.

The printer 13 includes, for example, a photosensitive drum 13a that transfers a toner to a recording medium, a drum heater 13b that evaporates water adhering to the surface of the photosensitive drum 13a, a feed cassette 13c that contains recording media to be fed to the photosensitive drum 13a, and a cassette heater 13d that dehumidifies recording media contained in the feed cassette 13c.

The storage device 18 stores a CO2 emissions estimation program 18a for use in estimating the CO2 emissions from the image forming apparatus 10. The CO2 emissions estimation program 18a may be installed on the image forming apparatus 10, for example, during production of the image forming apparatus 10, additionally installed thereon from an external storage medium, such as a USB (universal serial bus) memory, or sent via a network to the image forming apparatus 10 and additionally installed thereon.

The storage device 18 stores number-of-sheets-subjected-to-printing-start information 18b indicating on a daily basis the total number of recording media subjected to the start of printing by the printer 13 (hereinafter, referred to as “the numbers of sheets subjected to printing start”). Herein, the number of sheets subjected to printing start refers to the total number of recording media printed in a day. The storage device 18 further stores number-of-copies information indicating on a daily basis, out of the number of sheets by which printing by the printer 13 has been completed in a day (hereinafter, referred to as “the number of printed sheets”), the number of copies resulting from copy jobs in which the printer 13 prints images read from original documents by the scanner 14 on the same day (hereinafter, referred to as “the number of copies”). In other words, the number of copies on a daily basis is the total number of copies in a day. The storage device 18 further stores number-of-nonscanned-printed-sheets information 18d indicating on a daily basis the number of nonscanned printer-printed sheets (hereinafter, referred to as “the number of nonscanned printed sheets”) that is the number of printed sheets obtained by subtracting the number of copies from the total number of printed sheets per day. In other words, the number of nonscanned printed sheets on a daily basis is the total number of nonscanned printed sheets in a day. The storage device 18 further stores color copy ratio information 18e indicating on a daily basis the ratio of the number of multi-color copies to the total number of copies (hereinafter, referred to as “the color copy ratio”). In other words, the color copy ratio on a daily basis is the ratio of the number of multi-color copies to the total number of copies in a day. The storage device 18 further stores color print ratio information 18f indicating on a daily basis the ratio of the number of nonscanned multi-color printed sheets to the total number of nonscanned printed sheets (hereinafter, referred to as “the color print ratio”). In other words, the color print ratio on a daily basis is the ratio of the number of nonscanned multi-color printed sheets to the total number of nonscanned printed sheets in a day. The storage device 18 further stores: duplex printing ratio information 18g indicating on a daily basis the ratio of the number of duplex printed sheets to the total number of printed sheets (hereinafter, referred to as “the duplex printing ratio”); number-of-scanned-sheets information 18h indicating on a daily basis the number of original documents read by the scanner 14, i.e., the number of sheets subjected to scanning by the scanner 14 (hereinafter, referred to as “the number of scanned sheets”), and number-of-faxed-sheets information 18i indicating on a daily basis the number of sheets sent by the facsimile communication device 16, i.e., the number of sheets subjected to facsimile transmission by the facsimile communication device 16 (hereinafter, referred to as “the number of faxed sheets”).

The number of sheets subjected to printing start is, for example, information for use in knowing the lives of various components and is counted up with the timing of start of printing of each sheet by the printer 13. The number of copies and the number of nonscanned printed sheets are information for use in billing and are each counted up with the timing of completion of printing of each sheet by the printer 13. For example, if a recording medium is jammed in the course of printing by the printer 13, i.e., if a sheet jam occurs, a difference is created between the number of sheets subjected to printing start and the sum of the number of copies and the number of nonscanned printed sheets and, therefore, the number of occurrences of jam can be estimated according to the difference.

The number of nonscanned printed sheets includes the number of sheets printed based on received faxed sheets, i.e., the number of sheets having been printed by the printer 13 from images represented by data received by the facsimile communication device 16.

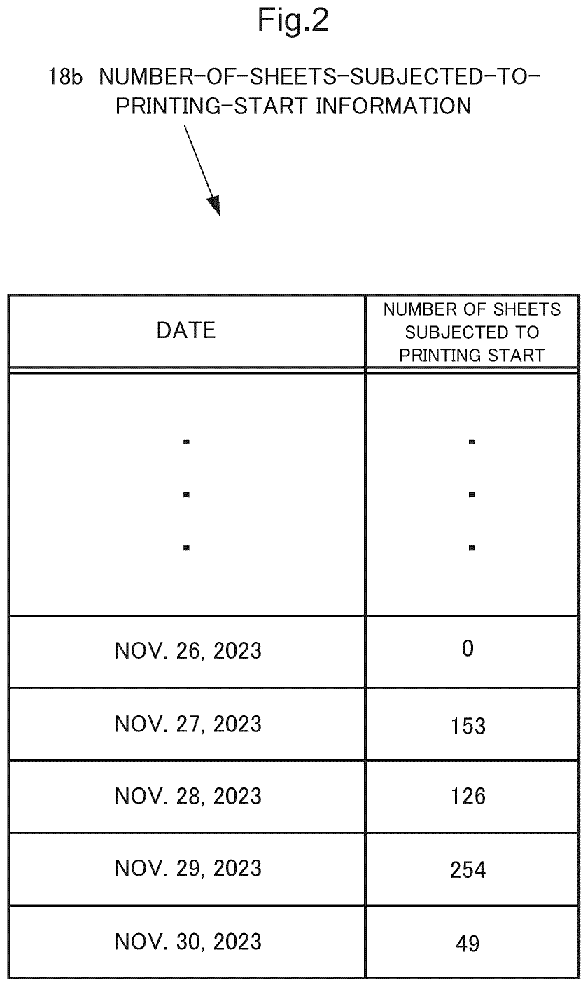

FIG. 2 is a table showing an example of the number-of-sheets-subjected-to-printing-start information 18b.

As shown in FIG. 2, the number-of-sheets-subjected-to-printing-start information 18b indicates the daily numbers of sheets subjected to printing start. In FIG. 2, the values on some dates (such as days before Nov. 26, 2023) are omitted. In FIG. 2, the numbers of sheets subjected to printing start on the dates other than the last day (the current day on which the number-of-sheets-subjected-to-printing-start information 18b has been disclosed, Nov. 30, 2023 in this example) are shown as the daily numbers of sheets subjected to printing start on the dates. The number of sheets subjected to printing start on the last day is shown as the number of sheets subjected to printing start at the last update time on the last day.

Although, heretofore, the description of the number-of-sheets-subjected-to-printing-start information 18b has been given, the number-of-copies information 18c, the number-of-nonscanned-printed-sheets information 18d, the color copy ratio information 18e, the color print ratio information 18f, the duplex printing ratio information 18g, the number-of-scanned-sheets information 18h, and the number-of-faxed-sheets information 18i likewise indicate the daily numbers of copies, the daily numbers of nonscanned printed sheets, daily color copy ratios, daily color print ratios, daily duplex printing ratios, the daily numbers of scanned sheets, and the daily numbers of faxed sheets, respectively.

As shown in FIG. 1, the storage device 18 is capable of storing: sleep mode setting value information 18j indicating on a daily basis a setting value for the sleep mode of the image forming apparatus 10 (hereinafter, referred to as a “sleep mode setting value”; drum heater setting value information 18k indicating on a daily basis a setting value of ON or OFF of the drum heater 13b (hereinafter, referred to as a “drum heater setting value”); cassette heater setting value information 18l indicating on a daily bases a setting value of ON or OFF of the cassette heater 13d (hereinafter, referred to as a “cassette heater setting value”), and IC card reader connection setting value information 18m indicating on a daily basis a setting value of whether or not the IC card reader 20 is connected to the IC card reader connecting device 17 (hereinafter, referred to as an “IC card reader connection setting value”).

The sleep mode setting value is either one of two different sleep modes: a deep sleep mode where the image forming apparatus 10 has the lowest power consumption; and a light sleep mode where the image forming apparatus 10 consumes more power than in the deep sleep mode. The image forming apparatus 10 can change the sleep mode setting value according to a user's instruction through the operation device 11 or the communication device 15.

The image forming apparatus 10 can change the drum heater setting value and the cassette heater setting value according to an instruction from a service person through the operation device 11 or the communication device 15.

When the IC card reader 20 is connected to the IC card reader connecting device 17, the IC card reader connection setting value is “ON”. When the IC card reader 20 is not connected to the IC card reader connecting device 17, the IC card reader connection setting value is “OFF”.

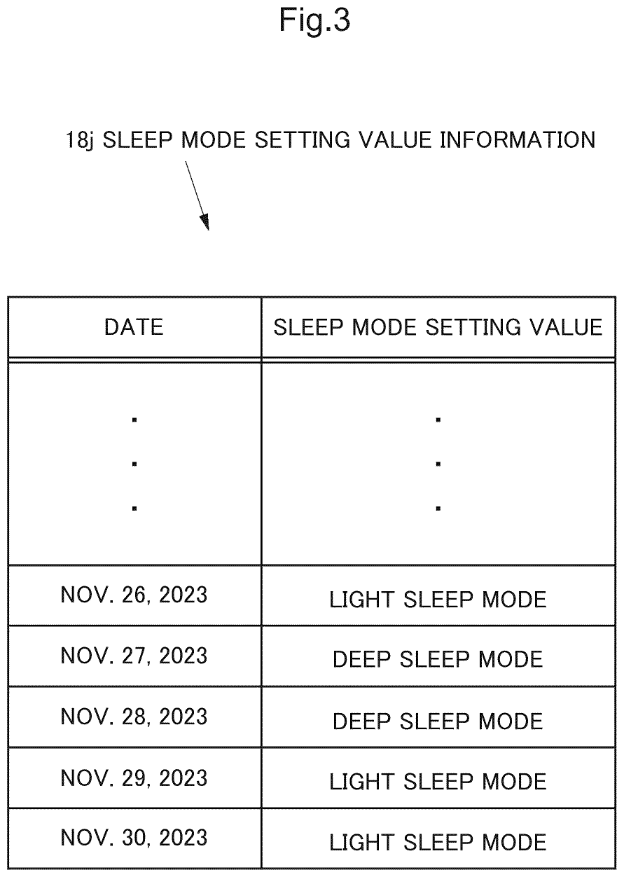

FIG. 3 is a table showing an example of the sleep mode setting value information 18j.

As shown in FIG. 3, the sleep mode setting value information 18j indicates daily sleep mode setting values. In FIG. 3, the values on some dates (such as days before Nov. 26, 2023) are omitted. In FIG. 3, the sleep mode setting values on the dates other than the last day (the current day on which the sleep mode setting value information 18j has been displayed, Nov. 30, 2023 in this example) are shown as the sleep mode setting values at the respective final times on the days. The sleep mode setting value on the last day is shown as the sleep mode setting value at the latest time on the last day.

Although, heretofore, the description of the sleep mode setting value information 18j has been given, the drum heater setting value information 18k, the cassette heater setting value information 18l, and the IC card reader connection setting value information 18m likewise indicate daily drum heater setting values, daily cassette heater setting values, and daily IC card reader connection setting values, respectively.

As shown in FIG. 1, the storage device 18 is capable of storing estimated emissions information 18n indicating on a daily bases an estimated value of CO2 emissions from the image forming apparatus 10.

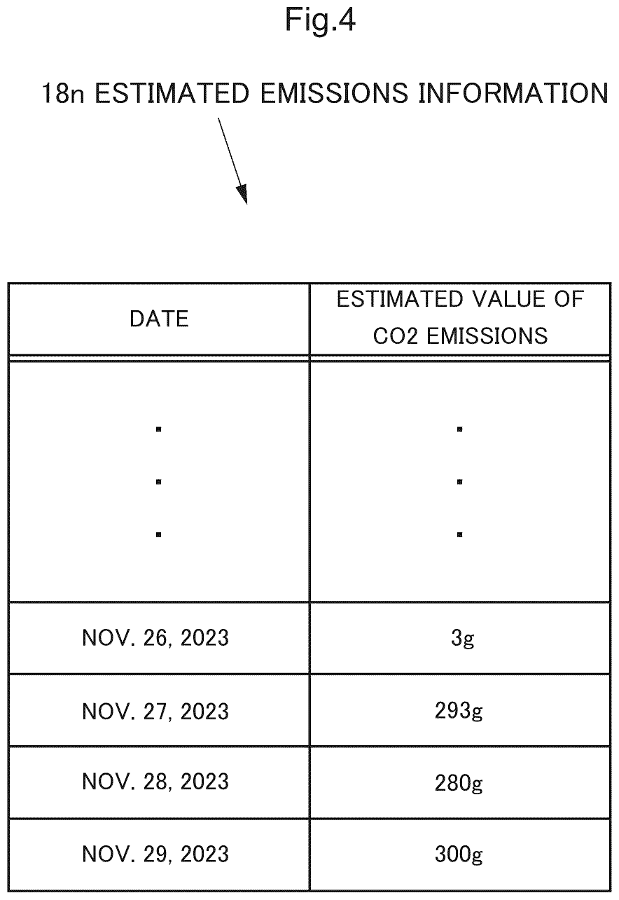

FIG. 4 is a table showing an example of the estimated emissions information 18n.

As shown in FIG. 4, the estimated emissions information 18n indicates daily estimated values of CO2 emissions. In FIG. 4, the values on some dates are omitted.

The controller 19 shown in FIG. 1 includes, for example, a CPU (central processing unit) composed of a processor or the like, a ROM (read only memory) that stores programs and various types of data, and a RAM (random access memory) as a memory for use as a working area for the CPU of the controller 19. The CPU of the controller 19 executes a program stored in the storage device 18 or the ROM of the controller 19.

By executing the CO2 emissions estimation program 18a, the controller 19 realizes an emissions estimator 19a that estimates the CO2 emissions from the image forming apparatus 10.

The following formula is, among CO2 emissions estimation models as formulae used by the emissions estimator 19a in estimating the CO2 emissions from the image forming apparatus 10, a job execution date emissions estimation model, which is a first estimation model for use in estimating the daily CO2 emissions from the image forming apparatus 10 on the date of execution of any job by the image forming apparatus 10.

$${Y}^{⋀} = \{ ( {a}_{1} {x}_{1} + {a}_{2} {x}_{2} + … + {a}_{n} {x}_{n} ) + ( {b}_{1} {y}_{1} + {b}_{2} {y}_{2} + … + {b}_{n} {y}_{n} ) + c \} \times ( CO 2 emissions factor ) \qquad [ Math . 1 ]$$

Y\hat{ }: objective variable (estimated value of CO2 emissions)
xₙ: explanatory variable
aₙ: partial regression coefficient
yₙ: explanatory variable
bₙ: partial regression coefficient
c: constant term

In the job execution date emissions estimation model, an arithmetic expression inside the curly bracket on the right side of the formula is a power consumption estimation model as a multiple regression expression for determining an estimated value of a daily power consumption of the image forming apparatus 10 on the date of execution of any job (hereinafter, referred to as a “job execution date power consumption estimation model”). In the job execution date emissions estimation model, n is sufficient to be an integer of 1 or more and preferably an integer of 2 or more.

In the job execution date emissions estimation model, explanatory variables xₙ may be present, for example, each according to a different type of information on the execution of a job (hereinafter, referred to as “job execution information”). For example, there may be employed as xₙ the number of sheets subjected to printing start, the number of copies, the number of nonscanned printed sheets, the color copy ratio, the color print ratio, the duplex printing ratio, the number of scanned sheets, and the number of faxed sheets.

In the job execution date emissions estimation model, explanatory variables yₙ may be present, for example, each according to a different type of setting value for the image forming apparatus 10. For example, there may be employed as yₙ the sleep mode setting value, the drum heater setting value, the cassette heater setting value, and the IC card reader connection setting value. Each of the sleep mode setting value, the drum heater setting value, the cassette heater setting value, and the IC card reader connection setting value is not a quantity. Therefore, the respective values to be input as the explanatory variable for the sleep mode setting value, the explanatory variable for the drum heater setting value, the explanatory variable for the cassette heater setting value, and the explanatory variable for the IC card reader connection setting value are respective quantities previously associated with the sleep mode setting value, the drum heater setting value, the cassette heater setting value, and the IC card reader connection setting value. As for the sleep mode setting value, for example, 1 may be associated with the deep sleep mode and 0 may be associated with the light sleep mode. Furthermore, as for the drum heater setting value, the cassette heater setting value, and the IC card reader connection setting value, 1 may be associated with ON and 0 may be associated with OFF.

The following formula is, among the CO2 emissions estimation models, a job non-execution date emissions estimation model, which is a second estimation model for use in estimating the daily CO2 emissions from the image forming apparatus 10 on the date when no job has been executed by the image forming apparatus 10.

$${Y}^{⋀} = ( {d}_{1} {y}_{1} + {d}_{2} {y}_{2} + … + {d}_{n} {y}_{n} + e ) \times ( CO 2 emissions factor ) \qquad [ Math . 2 ]$$

Y\hat{ }: objective variable (estimated value of CO2 emissions)
yₙ: explanatory variable
dₙ: partial regression coefficient
e: constant term

In the job non-execution date emissions estimation model, an arithmetic expression inside the parentheses on the right side of the formula is a power consumption estimation model as a multiple regression expression for determining an estimated value of a daily power consumption of the image forming apparatus 10 on the date when no job has been executed (hereinafter, referred to as a “job non-execution date power consumption estimation model”).

In the job non-execution date emissions estimation model, n is sufficient to be an integer of 1 or more and preferably an integer of 2 or more.

In the job non-execution date emissions estimation model, explanatory variables yₙ are the same as those in the job execution date emissions model.

Next, a description will be given of the configuration of a model generation system for use in generating a CO2 emissions estimation model.

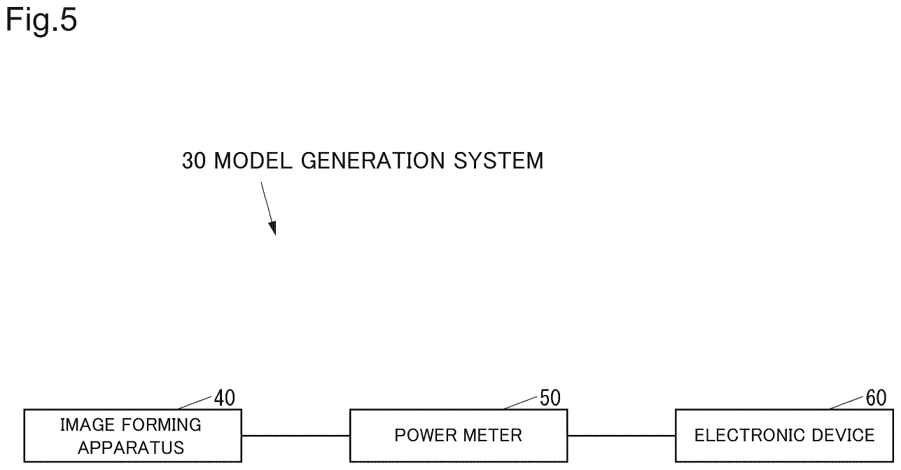

FIG. 5 is a block diagram showing an example of a model generation system 30 for generating a CO2 emissions estimation model for use on the image forming apparatus 10. As shown in FIG. 5, the model generation system 30 includes: an image forming apparatus 40 of the same type as the image forming apparatus 10 (see FIG. 1); a power meter 50 that measures the power consumption of the image forming apparatus 40; and an electronic device 60, such as a smartphone or a tablet, that stores the power consumption measured by the power meter 50.

Next, a description will be given of a method for generating a CO2 emissions estimation model.

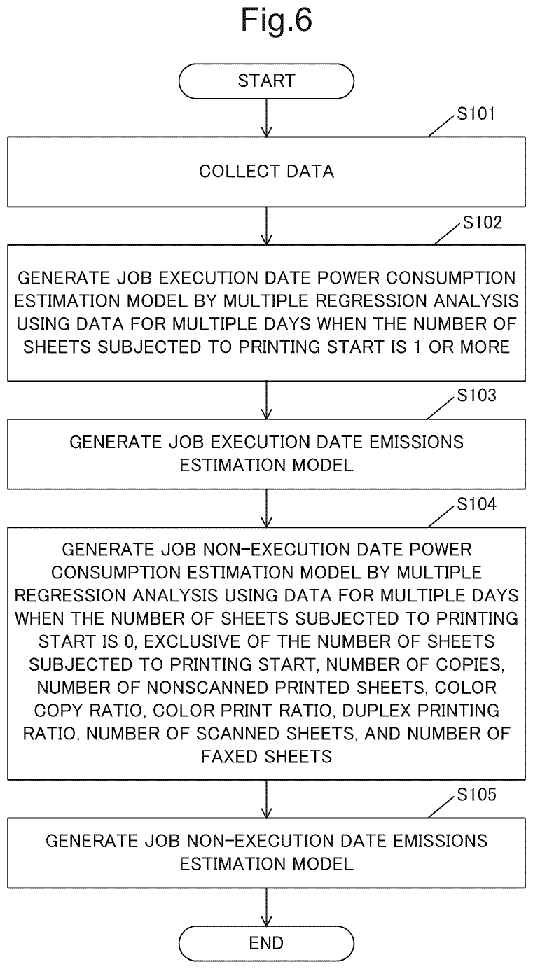

FIG. 6 is a flowchart of a method for generating a CO2 emissions estimation model for use on the image forming apparatus 10.

As shown in FIG. 6, an operator collects a lot of data for use in generating a power consumption estimation model (S101). Specifically, the operator stores, in the electronic device 60, data for a plurality of days in which on a daily basis the power consumption of the image forming apparatus 40 measured by the power meter 50 is associated with the number of sheets subjected to printing start, the number of copies, the number of nonscanned printed sheets, the color copy ratio, the color print ratio, the duplex printing ratio, the number of scanned sheets, and the number of faxed sheets on the image forming apparatus 40, the sleep mode setting value, the drum heater setting value, the cassette heater setting value, and the IC card reader connection setting value.

When the step S101 ends, the operator generates a job execution date power consumption estimation model by multiple regression analysis using, among the lot of data collected in S101, data for a plurality of days when the number of sheets subjected to printing start is one or more (S102). Specifically, the operator instructs the electronic device 60 to generate a job execution date power consumption estimation model by multiple regression analysis using, among the lot of data collected in S101, data for a plurality of days when the number of sheets subjected to printing start is one or more. Thus, the electronic device 60 generates a job execution date power consumption estimation model by multiple regression analysis using, among the lot of data collected in S101, data for a plurality of days when the number of sheets subjected to printing start is one or more. The generation of a job execution date power consumption estimation model in S102 may be performed by machine learning.

When the step S102 ends, the operator generates a job execution date emissions estimation model using the job execution date power consumption estimation model generated in S102 (S103). Specifically, the operator instructs the electronic device 60 to generate a job execution date emissions estimation model using the job execution date power consumption estimation model generated in S102. Thus, the electronic device 60 multiplies the job execution date power consumption estimation model generated in S102 by a CO2 emissions factor, thus generating a job execution date emissions estimation model.

When the step S103 ends, the operator generates a job non-execution date power consumption estimation model by multiple regression analysis using, among the lot of data collected in S101, data for a plurality of days when the number of sheets subjected to printing start is zero, but with the exception of the number of sheets subjected to printing start, the number of copies, the number of nonscanned printed sheets, the color copy ratio, the color print ratio, the duplex printing ratio, the number of scanned sheets, and the number of faxed sheets (S104). Specifically, the operator instructs the electronic device 60 to generate a job non-execution date power consumption estimation model by multiple regression analysis using, among the lot of data collected in S101, data for a plurality of days when the number of sheets subjected to printing start is zero, but with the exception of the number of sheets subjected to printing start, the number of copies, the number of nonscanned printed sheets, the color copy ratio, the color print ratio, the duplex printing ratio, the number of scanned sheets, and the number of faxed sheets. Thus, the electronic device 60 generates a job non-execution date power consumption estimation model by multiple regression analysis using, among the lot of data collected in S101, data for a plurality of days when the number of sheets subjected to printing start is zero, but with the exception of the number of sheets subjected to printing start, the number of copies, the number of nonscanned printed sheets, the color copy ratio, the color print ratio, the duplex printing ratio, the number of scanned sheets, and the number of faxed sheets. The generation of a job non-execution date power consumption estimation model in S104 may be performed by machine learning.

When the step S104 ends, the operator generates a job non-execution date emissions estimation model using the job non-execution date power consumption estimation model generated in S104 (S105). Specifically, the operator instructs the electronic device 60 to generate a job non-execution date emissions estimation model using the job non-execution date power consumption estimation model generated in S104. Thus, the electronic device 60 multiplies the job non-execution date power consumption estimation model generated in S104 by a CO2 emissions factor, thus generating a job non-execution date emissions estimation model.

The CO2 emissions estimation model generated by the method shown in FIG. 6 is installed on an image forming apparatus, such as the image forming apparatus 10, of the same type as the image forming apparatus 40.

The model generation system shown in FIG. 5 and the method shown in FIG. 6 are merely illustrative. The CO2 emissions estimation model for use on the image forming apparatus 10 may be generated by any manner other than the manner shown in FIGS. 5 and 6.

Next, a description will be given of the operation of the image forming apparatus 10 when performing a job.

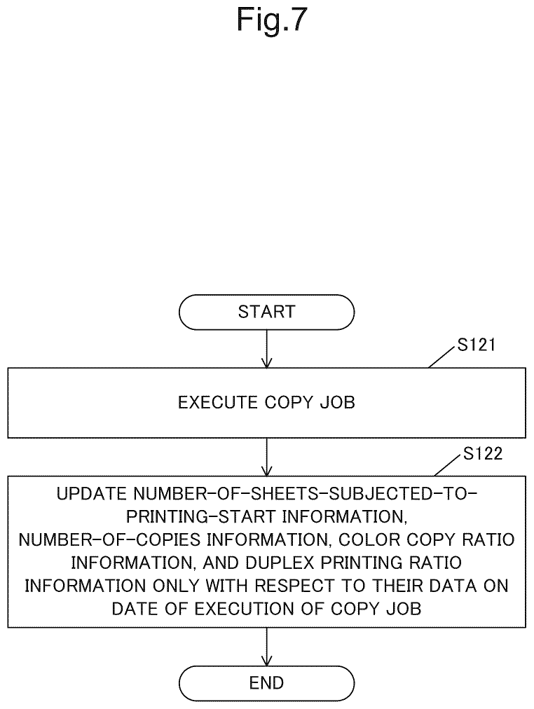

FIG. 7 is a flowchart of the operation of the image forming apparatus 10 when performing a copy job.

As shown in FIG. 7, when accepting an instruction to execute a copy job through the operation device 11, the controller 19 of the image forming apparatus 10 executes a copy job (S121).

When the processing in S121 ends, the emissions estimator 19a of the controller 19 updates, according to the result of execution of the copy job in S121, the number-of-sheets-subjected-to-printing-start information 18b, the number-of-copies information 18c, the color copy ratio information 18e, and the duplex printing ratio information 18g only with respect to data on the day when the copy job has been executed in S121 (S122), and then ends the operation shown in FIG. 7.

Heretofore, the description has been given taking a copy job as an example of the type of job. However, the same applies to different types of jobs other than copy job. For example, when the controller 19 executes a print job to allow the printer 13 to print an image based on data received through the communication device 15, the emissions estimator 19a updates, according to the result of execution of the print job, the number-of-sheets-subjected-to-printing-start information 18b, the number-of-nonscanned-printed-sheets information 18d, the color print ratio information 18f, and the duplex printing ratio information 18g only with respect to data of them on the day when the print job has been executed. For another example, when the controller 19 executes a received FAX print job to allow the printer 13 to print an image based on FAX data received through the facsimile communication device 16, the emissions estimator 19a updates, according to the result of execution of the received FAX print job, the number-of-sheets-subjected-to-printing-start information 18b, the number-of-nonscanned-printed-sheets information 18d, the color print ratio information 18f, and the duplex printing ratio information 18g only with respect to data of them on the day when the received FAX print job has been executed. For still another example, when the controller 19 executes a scan job to allow the scanner 14 to read an image from an original document, the emissions estimator 19a updates, according to the result of execution of the scan job, data of the number-of-scanned-sheets information 18h on the day when the scan job has been executed. For still another example, when the controller 19 executes a FAX transmission job to send through the facsimile communication device 16 an image read from an original document by the scanner 14, the emissions estimator 19a updates, according to the result of execution of the FAX transmission job, data of the number-of-faxed-sheets information 18i on the day when the FAX transmission job has been executed.

Each time the date changes, the emissions estimator 19a updates the number-of-sheets-subjected-to-printing-start information 18b, the number-of-copies information 18c, the number-of-nonscanned-printed-sheets information 18d, the number-of-scanned-sheets information 18h, and the number-of-faxed-sheets information 18i to set each of the number of sheets subjected to printing start, the number of copies, the number of nonscanned printed sheets, the number of scanned sheets, and the number of faxed sheets on the new day at zero. Furthermore, each time the date changes, the emissions estimator 19a updates the color copy ratio information 18e, the color print ratio information 18f, and the duplex printing ratio information 18g to set each of the color copy ratio, the color print ratio, and the duplex printing ratio on the new day at zero.

Next, a description will be given of the operation of the image forming apparatus 10 when changing a setting value for the image forming apparatus 10.

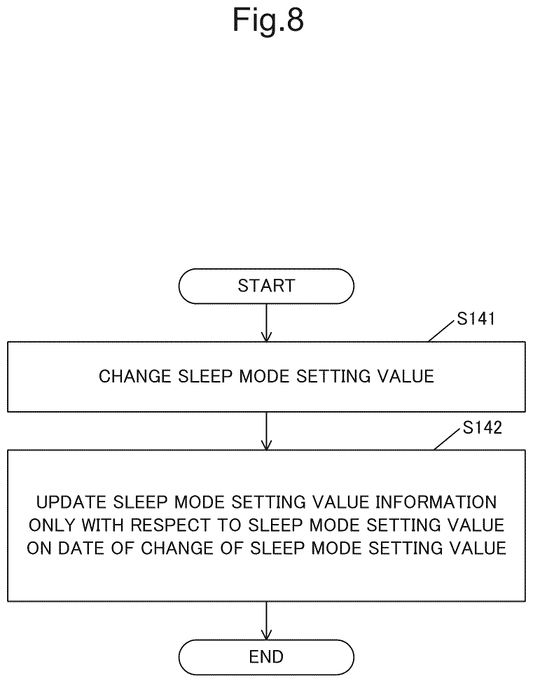

FIG. 8 is a flowchart of the operation of the image forming apparatus 10 when changing the sleep mode setting value.

As shown in FIG. 8, when instructed to change the sleep mode setting value through the operation device 11, the controller 19 of the image forming apparatus 10 changes the sleep mode setting value for the image forming apparatus 10 (S141). For example, when instructed to change the sleep mode setting value for the image forming apparatus 10 to the deep sleep mode through the operation device 11, the controller 19 changes the sleep mode setting value for the image forming apparatus 10 to the deep sleep mode.

When the processing in S141 ends, the emissions estimator 19a of the controller 19 updates, according to the result of change of the sleep mode setting value in S141, the sleep mode setting value information 18j only with respect to the sleep mode setting value on the day when the sleep mode setting value has been changed in S141 (S142), and then ends the operation shown in FIG. 8.

As for the sleep mode setting value of the sleep mode setting value information 18j on the day when the sleep mode setting value has not been changed, the emissions estimator 19a sets it at the same value as the sleep mode setting value on the last earlier date when the sleep mode setting value has been recorded.

Heretofore, the description has been given taking the sleep mode setting value as an example of the type of setting value for the image forming apparatus 10. However, the same applies to the setting values other than the sleep mode setting value. For example, when the drum heater setting value is changed, the emissions estimator 19a updates, according to the result of change of the drum heater setting value, the drum heater setting value information 18k only with respect to the drum heater setting value on the day when the drum heater setting value has been changed. For another example, when the cassette heater setting value is changed, the emissions estimator 19a updates, according to the result of change of the cassette heater setting value, the cassette heater setting value information 18l only with respect to the cassette heater setting value on the day when the cassette heater setting value has been changed. For still another example, when the IC card reader connection setting value is changed, the emissions estimator 19a updates, according to the result of change of the IC card reader connection setting value, the IC card reader connection setting value information 18m only with respect to the IC card reader connection setting value on the day when the IC card reader connection setting value has been changed.

Next, a description will be given of the operation of the image forming apparatus 10 when displaying an estimated value of CO2 emissions.

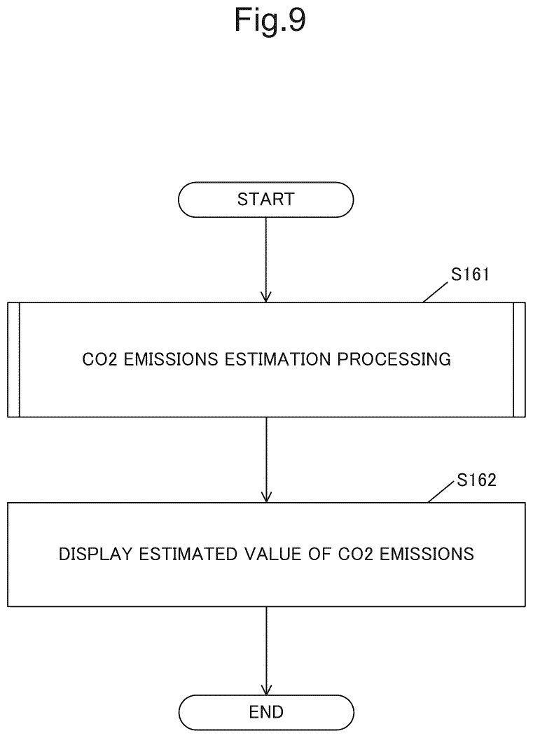

FIG. 9 is a flowchart of the operation of the image forming apparatus 10 when displaying an estimated value of CO2 emissions.

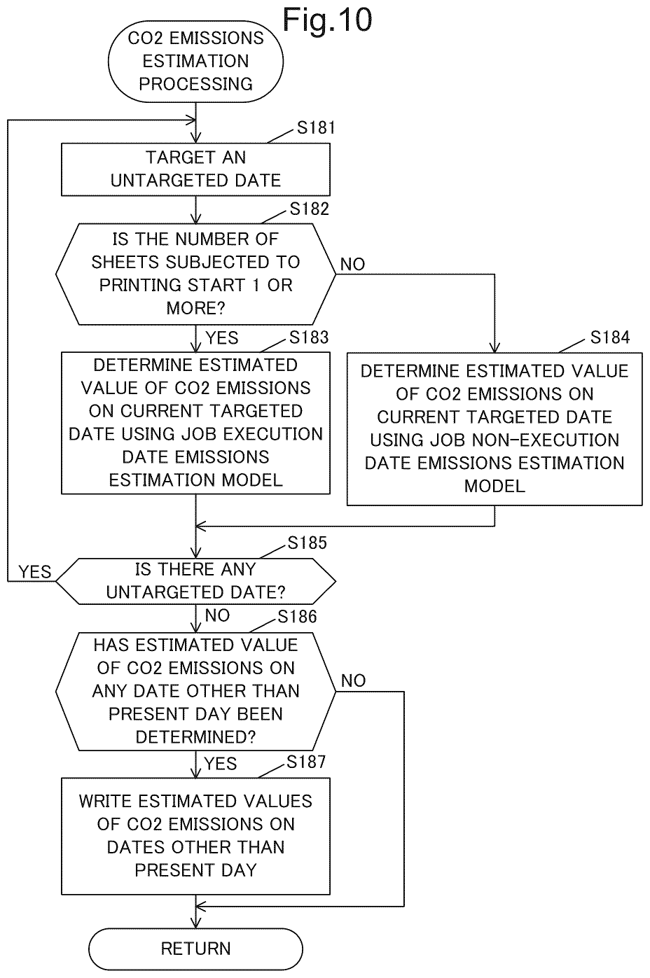

The user of the image forming apparatus 10 can instruct the image forming apparatus 10 through the operation device 11 to display an estimated value of CO2 emissions from the image forming apparatus 10. When instructed to display an estimated value of CO2 emissions from the image forming apparatus 10, the emissions estimator 19a of the image forming apparatus 10 executes, as shown in FIG. 9, CO2 emissions estimation processing (see FIG. 10) for determining an estimated value of CO2 emissions (S161).

FIG. 10 is a flowchart of CO2 emissions estimation processing shown in FIG. 9.

As shown in FIG. 10, the emissions estimator 19a targets, among dates included in the number-of-sheets-subjected-to-printing-start information 18b but not included in the estimated emissions information 18n, a date having not been targeted in the current processing shown in FIG. 10 (S181).

The emissions estimator 19a determines whether or not the number of sheets subjected to printing start in the number-of-sheets-subjected-to-printing-start information 18b associated with the currently targeted date is 1 or more (S182).

When determining that the number of sheets subjected to printing start in the number-of-sheets-subjected-to-printing-start information 18b associated with the currently targeted date is 1 or more, the emissions estimator 19a determines an estimated value of CO2 emissions from the image forming apparatus 10 on the currently targeted date, using the job execution date emissions estimation model and data on the currently targeted date about the number-of sheets-subjected-to-printing-start information 18b, the number-of-copies information 18c, the number-of-nonscanned-printed-sheets information 18d, the color copy ratio information 18e, the color print ratio information 18f, the duplex printing ratio information 18g, the number-of-scanned-sheets information 18h, the number-of-faxed-sheets information 18i, the sleep mode setting value information 18j, the drum heater setting value information 18k, the cassette heater setting value information 18l, and the IC card reader connection setting value information 18m (S183).

When determining that the number of sheets subjected to printing start in the number-of-sheets-subjected-to-printing-start information 18b associated with the currently targeted date falls short of 1, the emissions estimator 19a determines an estimated value of CO2 emissions from the image forming apparatus 10 on the currently targeted date, using the job non-execution date emissions estimation model and data on the currently targeted date about the sleep mode setting value information 18j, the drum heater setting value information 18k, the cassette heater setting value information 18l, and the IC card reader connection setting value information 18m (S184).

When the processing in S183 or the processing in S184 ends, the emissions estimator 19a determines whether or not there is, among dates included in the number-of-sheets-subjected-to-printing-start information 18b but not included in the estimated emissions information 18n, any date having not been targeted in the current processing shown in FIG. 10 (S185).

When determining in S185 that there is, among dates included in the number-of-sheets-subjected-to-printing-start information 18b but not included in the estimated emissions information 18n, any date having not been targeted in the current processing shown in FIG. 10, the emissions estimator 19a executes the processing in S181.

When determining in S185 that there is, among dates included in the number-of-sheets-subjected-to-printing-start information 18b but not included in the estimated emissions information 18n, no date having not been targeted in the current processing shown in FIG. 10, the emissions estimator 19a determines whether or not an estimated value of CO2 emissions on any date other than the present day has been determined in S183 or S184 (S186).

When determining in S186 that an estimated value of CO2 emissions on any date other than the present day has been determined in S183 or S184, the emissions estimator 19a writes to the estimated emissions information 18n, among the estimated values of CO2 emissions determined in S183 or S184, the estimated values of CO2 emissions on all the dates other than the present day (S187).

When the emissions estimator 19a determines in S186 that an estimated value of CO2 emissions on any date other than the present day has not been determined in S183 and S184 or when the processing in S187 ends, the emissions estimator 19a ends the CO2 emissions estimation processing shown in FIG. 10.

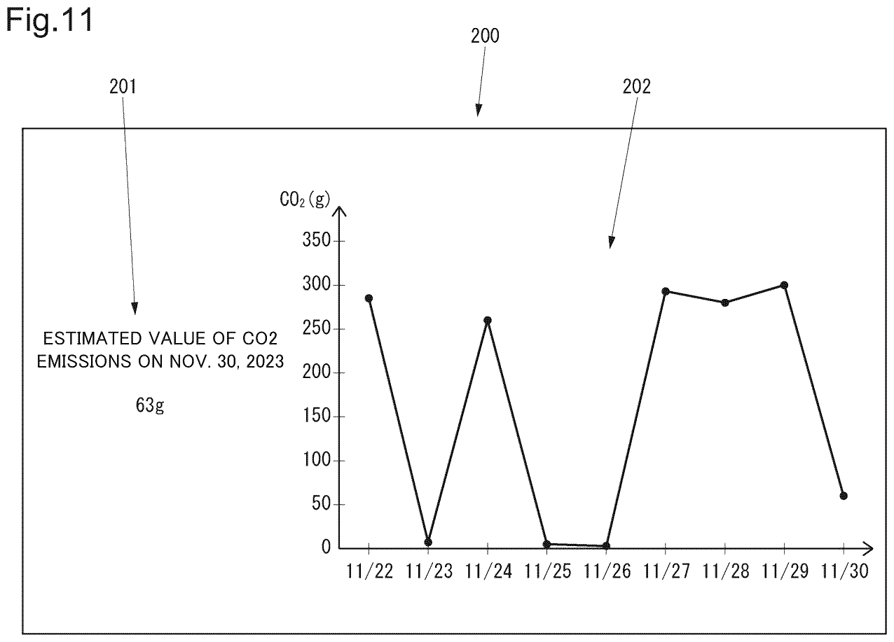

As shown in FIG. 9, when the execution of the CO2 emissions estimation processing in S161 ends, the emissions estimator 19a allows the display device 12 to display, based on the estimated emissions information 18n and the estimated value of CO2 emissions on the present day determined in the CO2 emissions estimation processing in S161, the estimated values of CO2 emissions from the image forming apparatus 10 (S162), for example, as shown in FIG. 11, and ends the operation shown in FIG. 9.

FIG. 11 is a view showing an example of a screen 200 that displays estimated values of CO2 emissions from the image forming apparatus 10.

The screen 200 shown in FIG. 11 contains: a region 201 where an estimated value of CO2 emissions on the present day is shown; and a graph 202 indicating changes in the estimated value of CO2 emissions from past to the present day.

As seen from the above, even though the power consumption of the image forming apparatus 10 is not measured by a power meter, the image forming apparatus 10 can determine an estimated value of CO2 emissions from the image forming apparatus 10 using a CO2 emission estimation model.

The image forming apparatus 10 uses a separate CO2 emissions estimation model in each of the case where the number of sheets subjected to any particular job on the image forming apparatus 10 in a day, i.e., the number of sheets subjected to printing start in a day, is 1 or more, i.e., the image forming apparatus 10 has executed any particular job in a day, and the case where the number of sheets subjected to printing start in a day falls short of 1, i.e., the image forming apparatus 10 has executed no particular job in a day (S182 to S184). Therefore, the image forming apparatus 10 can use the CO2 emissions estimation model according to the usage situation of the image forming apparatus 10 and, as a result, the accuracy of the estimated value of CO2 emissions from the image forming apparatus 10 can be increased.

The image forming apparatus 10 determines an estimated value of CO2 emissions from the image forming apparatus 10, using: a CO2 emissions estimation model which is a formula in which a multiple regression expression for determining an estimated value of a power consumption of the image forming apparatus 10 is multiplied by a CO2 emissions coefficient and which has explanatory variables each according to a different type of setting value for the image forming apparatus 10 and explanatory variables each according to a different type of job execution information for the image forming apparatus 10; setting values for the image forming apparatus 10; and the job execution information on the image forming apparatus 10 (S183). Therefore, the influence on the estimated value of CO2 emissions from the image forming apparatus 10 is not confused for each explanatory variable and, as a result, the accuracy of the estimated value of CO2 emissions from the image forming apparatus 10 can be increased.

Since the image forming apparatus 10 determines an estimated value of CO2 emissions from the image forming apparatus 10 using not only the job execution information on the image forming apparatus 10 but also the setting values for the image forming apparatus 10 (S183), the accuracy of the estimated value of CO2 emissions from the image forming apparatus 10 can be increased.

The general CO2 emissions estimation systems different from this embodiment have a problem of low accuracy of the estimated value of CO2 emissions from an image forming apparatus. Unlike them, in this embodiment, the accuracy of the estimated value of CO2 emissions from the image forming apparatus can be increased.

In this embodiment, the emissions estimator 19a notifies of the estimated value of CO2 emissions from the image forming apparatus 10 by displaying it. However, the emissions estimator 19a may notify of the estimated value of CO2 emissions from the image forming apparatus 10 by any method other than displaying it. For example, the emissions estimator 19a may notify of the estimated value of CO2 emissions from the image forming apparatus 10 by voice.

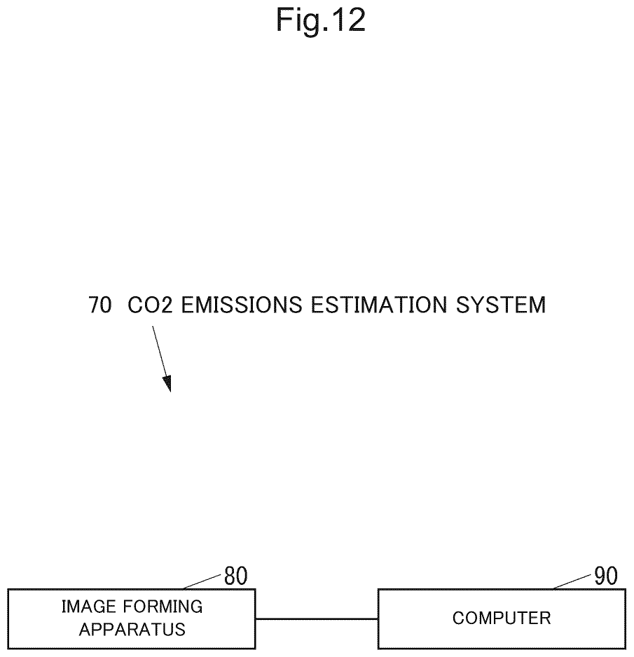

In the above example, the CO2 emissions estimation system is formed only of an image forming apparatus. However, the CO2 emissions estimation system according to this embodiment may be formed of an image forming apparatus and at least one computer other than the image forming apparatus. For example, the CO2 emissions estimation system according to this embodiment may have a configuration shown in FIG. 12.

FIG. 12 is a block diagram showing another example of a CO2 emissions estimation system according to this embodiment different from the example shown in FIG. 1.

A CO2 emissions estimation system 70 shown in FIG. 12 includes an image forming apparatus 80 and a computer 90. The image forming apparatus 80 and the computer 90 are connected communicably to each other. The computer 90 determines, like the processing in S161, an estimated value of CO2 emissions from the image forming apparatus 80 based on various types of information received from the image forming apparatus 80. The user of the image forming apparatus 80 may be notified of the estimated value of CO2 emissions of the image forming apparatus 80 determined by the computer 90 from either the image forming apparatus 80 or the computer 90.

As seen from the above, the CO2 emissions estimation system according to this embodiment switches between CO2 emissions estimation models according to whether or not the number of sheets subjected to printing start per day is 1 or more. However, the CO2 emissions estimation system according to the present disclosure may use, as a criterion of whether to switch between the CO2 emissions estimation models, the number of sheets other than the number of sheets subjected to printing start so long as the number of sheets is the number of sheets subjected to any particular job on the image forming apparatus. For example, the CO2 emissions estimation system according to the present disclosure may use, as a criterion of whether to switch between the CO2 emissions estimation models, one or more of the number of copies, the number of nonscanned printed sheets, the number of scanned sheets, and the number of faxed sheets.

The job execution date emissions estimation model of the CO2 emissions estimation system according to this embodiment has not only an explanatory variable according to a different type of job execution information on the image forming apparatus, but also an explanatory variable according to a different type of setting value for the image forming apparatus. However, the job execution date emissions estimation model may have either an explanatory variable according to a different type of job execution information or alternatively an explanatory variable according to a different type of the setting value.

The job non-execution date emissions estimation model of the CO2 emissions estimation system according to this embodiment has an explanatory variable according to a different type of the setting value for the image forming apparatus, but does not have any explanatory variable according to a different type of job execution information on the image forming apparatus. However, the job non-execution date emissions estimation model of the CO2 emissions estimation system according to the present disclosure may have, like the job execution date emissions estimation model, an explanatory variable according to a different type of the setting value for the image forming apparatus and/or an explanatory variable according to a different type of the job execution information on the image forming apparatus.

As described above, the CO2 emissions estimation system according to this embodiment determines an estimated value of the CO2 emissions from the image forming apparatus in a day. However, the CO2 emissions estimation system according to the present disclosure may determine an estimated value of the CO2 emissions from the image forming apparatus, not in a day, but in a specified period.

While the present disclosure has been described in detail with reference to the embodiments thereof, it would be apparent to those skilled in the art that the various changes and modifications may be made therein within the scope defined by the appended claims.

What is claimed is:

1. A CO2 emissions estimation system comprising a control device that includes a processor and functions, through the processor executing a CO2 emissions estimation program, as an emissions estimator,
wherein the emissions estimator determines an estimated value of CO2 emissions from an image forming apparatus, using an estimation model as a formula for estimating the emissions,
wherein when a number of sheets subjected to a particular job on the image forming apparatus in a specified period is 1 or more, the emissions estimator determines an estimated value of the emissions in the specified period using a first estimation model as the estimation model, and
wherein when the number of sheets subjected to the particular job on the image forming apparatus in the specified period falls short of 1, the emissions estimator determines an estimated value of the emissions in the specified period using as the estimation model a second estimation model different from the first estimation model.

2. The CO2 emissions estimation system according to claim 1,
further comprising a display device,
wherein the emissions estimator allows the display device to display a graph indicating changes in the estimated value of CO2 emissions on a basis of a predetermined specified period.

3. A non-transitory computer-readable recording medium with a CO2 emission estimation program stored thereon,
wherein the CO2 emission estimation program allows a computer to realize an emissions estimator that determines an estimated value of CO2 emissions from an image forming apparatus, using an estimation model as a formula for estimating the emissions,
wherein when a number of sheets subjected to a particular job on the image forming apparatus in a specified period is 1 or more, the emissions estimator determines an estimated value of the emissions in the specified period using a first estimation model as the estimation model, and
wherein when the number of sheets subjected to the particular job on the image forming apparatus in the specified period falls short of 1, the emissions estimator determines an estimated value of the emissions in the specified period using as the estimation model a second estimation model different from the first estimation model.
